(19) United States
(12) Patent Application Publication
(10) Pub. No.: US 2006/0082242 A1
(43) Pub. Date: Apr. 20, 2006

(54) Stator arrangement for an electric machine and an electric motor

(76) Inventor: Jurgen Schill, Bad Durrheim (DE)

Correspondence Address: Mark C. Comtois;DUANE MORRIS LLP, Suite 700, 1667 K Street N.W., Washington, DC, 20006, US

(21) Appl. No.: 11/225,122

(22) Filed: Sep. 14, 2005

(30) Foreign Application Priority Data
Oct. 15, 2004 (DE) 10 2004 050 373.7

(51) Int. Cl. H02K 1/04; H02K 1/06

(52) U.S. Cl. 310/217; 310/43; 310/254

(57) ABSTRACT

A stator arrangement for an electric machine comprising a stator body having a number of stator teeth between which stator slots to receive stator windings are formed, and having an insulating layer that is applied to the stator teeth at least in the region of the stator slots in which the stator windings are accommodated, the insulating layer being integrally formed with a housing member that is injection molded to the stator body, regions of the stator body that do not receive any stator windings remaining at least partly uncovered.

### FIELD OF THE INVENTION

The invention relates to a stator arrangement for an electric machine and an electric motor. The stator arrangement according to the invention can be employed in many different types of electric machines, particularly in DC motors and generators.

A preferred field of application for the invention is in brushless DC motors and other permanent magnet motors that can be configured as inner rotor motors or as outer rotor motors.

### BACKGROUND OF THE INVENTION

Electric motors having an inner rotor motor configuration have a rotor back yoke that is mounted onto a shaft and one or more permanent magnets that are mounted onto the rotor back yoke or embedded in the back yoke. The motors additionally comprise a stator arrangement consisting, for example, of a number of stacked metal laminations which form an annular stator back yoke from which stator teeth protrude radially inwards. The stator teeth form the stator poles between which stator slots to receive stator windings are formed. The rotor arrangement is inserted coaxially into the stator arrangement. In the case of an outer rotor motor configuration, the rotor arrangement encloses the stator coaxially.

It is common practice for the rotor and the stator to be accommodated in a housing that has at least one end flange for the purpose of fastening the motor.

In most motors, the stator is made up of a slotted stack of laminations, the stator windings, made, for example, from insulated copper wire, being accommodated in the stator slots. Before the stator is wound, it is necessary to electrically insulate the stator slots. To this effect, it is known to apply an insulating layer to the slots, by means, for example of powder coating or injection molding. Another approach is to mount coil carriers made of plastics onto the stator teeth or to place plastic disks over the slots.

A brushless DC motor is known from DE 197 40 938 A1 whose stator body has an insulating layer in the region of the stator teeth in which the stator windings are accommodated. The insulating layer is applied to the stator body by means of injection molding and a carrying element for the terminal contacts, to which the ends of the windings are connected, is integrally formed with the insulating layer. The DC motor is accommodated in a separate housing.

From DE 102 54 670 A1, an electric motor for a pump drive is known in which the stator is embedded in a plastic member and the plastic member together with the stator forms a space in which the rotor is accommodated, this space being closed at one end face and the rotor being connected to an impeller at the opposite end face. This arrangement makes a can, as normally found in pump motors, superfluous, and, in addition, the plastic member forms a part of the motor housing. The electric motor described in DE 102 54 670 A1 has the disadvantage, however, that external heat dissipation in the stator is not optimal.

It is the object of the invention to provide a stator arrangement for an electric machine and an electric motor that can be simply manufactured at low cost and that show good properties with respect to heat dissipation in the stator.

### SUMMARY OF THE INVENTION

The invention provides a stator arrangement for an electric machine which has a stator body having a number of stator teeth between which stator slots to receive windings are formed. The stator teeth are provided with an insulating layer at least in the region of the stator slots in which the stator windings are accommodated in order to insulate the stator body vis-à-vis the stator windings. According to the invention, the insulating layer is integrally formed with a housing that is injection molded to the stator body; at the same time, regions of the stator body that do not receive any stator windings remain at least partly uncovered. The stator body is preferably configured as an inner rotor motor. In this preferred embodiment, the stator body forms a back yoke ring from which stator teeth project radially inwards. The insulating layer and the housing are injection molded onto the stator body such that the outside surface of the back yoke ring remains uncovered. This makes it possible for a motor housing to be directly formed onto the stator and good heat dissipation from the stator to the outside to still be guaranteed. The insulation of the stator slots and the fabrication of the housing in one production step can be realized at low cost.

Connecting elements to connect the housing to at least one flange are preferably formed on the housing. For example, locking elements, recesses and/or holes can be provided in the housing in order to connect one or two end flanges to the housing. In an alternative embodiment, a flange can be directly formed on an end face of the housing. This measure makes it even easier to assemble the electric motor having the stator arrangement according to the invention.

The invention also provides an electric motor having a stator arrangement of the type described above, wherein the housing is injection molded onto the stator body such that it has two housing sections on the opposing end faces of the stator body which preferably are substantially flush with the outside surface of the back yoke ring of the stator body. This goes to produce a particularly compact and place-saving motor configuration in which the stator body can conduct heat to the outside. There is no need to provide a separate housing.

### SHORT DESCRIPTION OF THE DRAWINGS

The invention is described in more detail below on the basis of preferred embodiments with reference to the drawings. The figures show:

FIG. 1 a schematic perspective view of a stator body according to the prior art;

FIG. 2 a schematic perspective view of a stator arrangement according to the invention seen from a first end face of the stator arrangement;

FIG. 3 a perspective view of the stator arrangement according to the invention seen from a second opposing end face of the stator arrangement;

FIG. 4a an end view of the stator arrangement according to the invention in which the first end face is shown;

FIG. 4b a longitudinal section through the stator arrangement according to the invention along the line A-A in FIG. 4a;

FIG. 4c another end view of the stator arrangement according to the invention in which the opposing second end face is shown:

FIG. 5 a perspective exploded view of an electric motor according to the invention.

### DETAILED DESCRIPTION OF PREFERRED EMBODIMENTS

FIG. 1 shows a perspective view of a stator body according to the prior art as can also be used in the stator arrangement according to the invention. The stator body 10 comprises a back yoke ring 12 and stator teeth 14 projecting radially inwards from the back yoke ring 12. Stator slots 16 are formed between the stator teeth 14, the stator slots receiving stator windings (not illustrated in the figures) that are wound about the stator teeth 14.

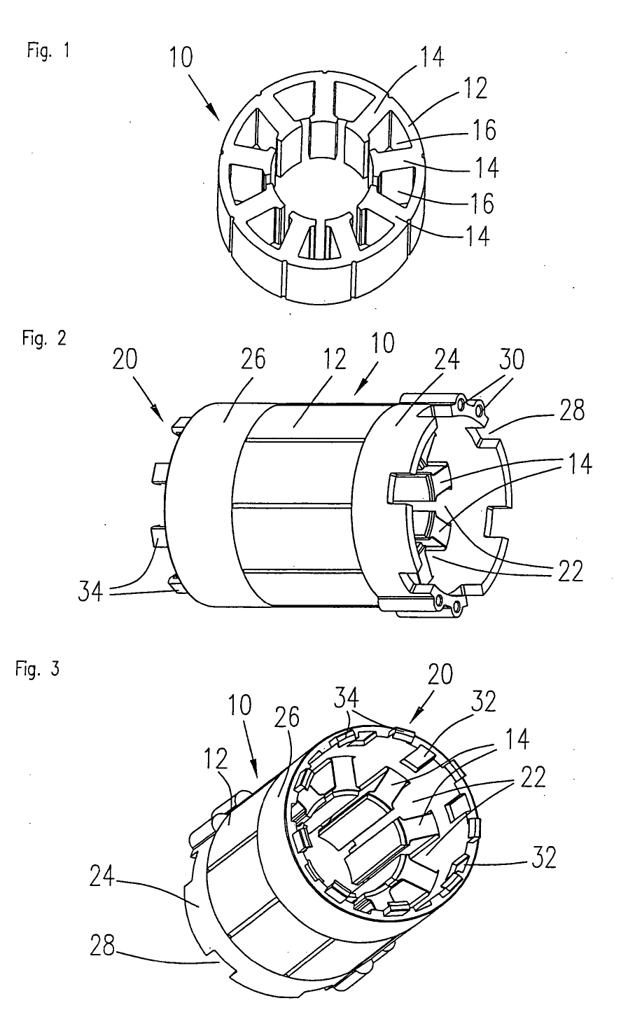

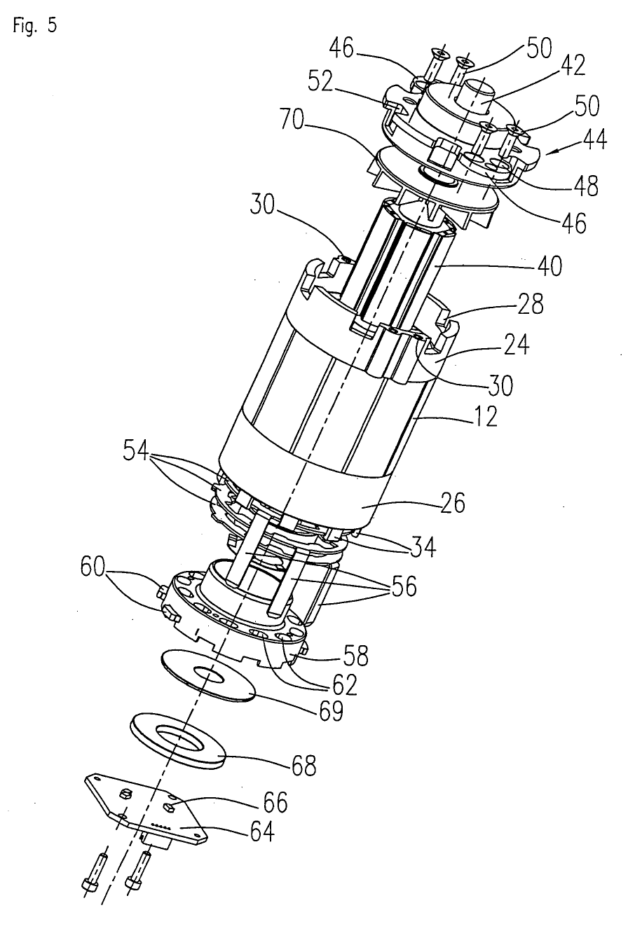

FIGS. 2 and 3 each show a perspective view of the stator arrangement according to the invention seen from a first and a second end face of the stator arrangement respectively. The first end face represents the drive side of the electric motor and the second end face represents the power supply side of the electric motor, as will become more apparent with reference to FIG. 5.

The stator arrangement comprises a stator body 10 having a back yoke ring 12 and stator teeth 14. A housing member 20, preferably made of plastics, is formed on the stator body 10, the housing member comprising an insulating layer 22 in the stator slots and the end housing sections 24, 26. The insulating layer 22 is preferably formed such that the bottom of the stator slots and the stator teeth are fully injection molded, the front end of the stator teeth facing the rotor, however, remaining free so as not to needlessly increase the size of the air gap between the stator and the rotor magnets.

The housing member 20 is preferably designed in such a way that the two end housing sections 24, 26 are flush with the outside surface of the back yoke ring 12 and directly adjoin the back yoke ring. In this way, the stator arrangement forms a single unit closed to the outside making an extra separate housing unnecessary. Recesses 28 and holes 30 are formed in the housing section 24 that corresponds to the drive side of the stator arrangement, the recesses and holes being used to position and fasten an A-flange, i.e. a flange on the drives side, as is explained in more detail with reference to FIG. 5.

Recesses 32 and locking lugs 34 are likewise provided on the opposite housing section 26 associated with the power supply of the electric motor, the recesses and locking lugs interacting with a B-flange on the opposing end face of the electric motor, which again will become more apparent in FIG. 5.

Thus, according to the invention, a stator arrangement is provided in which the housing member 20 together with the insulating layer 22 is formed on the stator body 10 in one production process, this housing member 20 together with the outside surface of the back yoke ring 12 of the stator body 10 forming a closed outer wall for the electric motor. Moreover, means of connecting the housing member to two flanges are formed on the end faces of the housing member 20. In an alternative embodiment of the invention which is not illustrated in the drawings, one of the end flanges could be integrally formed with the housing member 20. The housing member 20 and the insulating layer 22 are preferably formed as a plastic injection-molded part.

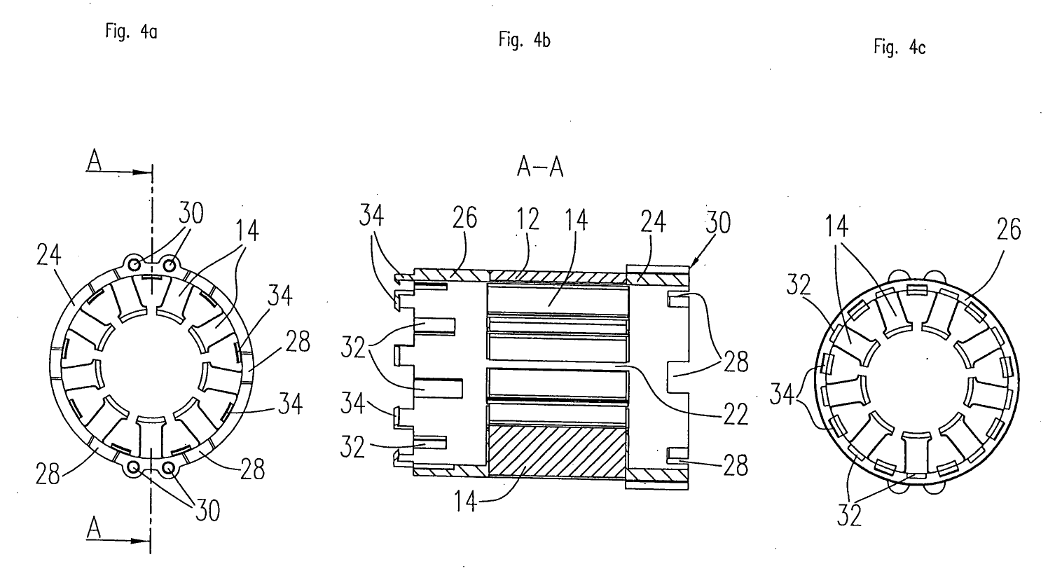

FIGS. 4a to 4c show two end views of the stator body according to the invention and a longitudinal view through the stator body. Elements corresponding to those in FIGS. 1 to 3 are indicated by the same reference number.

FIG. 5 shows a perspective exploded view of an electric motor that has the stator arrangement according to the invention. Elements corresponding to those in FIGS. 1 to 3 are indicated by the same reference number.

A rotor 40 that is mounted onto a shaft 42 is coaxially inserted into the stator arrangement. An A-flange 44 is disposed at the drive side of the motor that is located at housing section 24, the A-flange having holes 48 in the flange sections 46 which are brought into line with the holes 30 in the housing section 24. The A-flange 44 can be connected to the housing section 24 by means of screws 50, rivets or similar connecting elements through the holes 48, 30. In the illustrated embodiment, the A-flange 44 has recesses 52 on its circumference which are aligned with the recesses 28 on the housing section 24. The recesses 52, 28 act as ventilation slits to admit air which is moved using a fan wheel 70, in order to ventilate and cool the DC motor.

At the opposite end of the electric motor, at housing section 26, which is associated with the power supply for the motor, three lead frames or connecting rings 54 are illustrated in the embodiment of FIG. 5 that act as a contact for the phase windings of the electric motor (not illustrated). Each connecting ring has a terminal lug 56 which projects from the housing after the electric motor has been assembled and is used to connect a power supply. The connecting rings 54 are held in the housing section 26 by recesses 32. The housing section 26 is closed by a cover or B-flange 58, the B-flange 58 having projections 60 which act as a height-stop on the housing member 30. After the B-flange 58 has been mounted onto the housing section 26, it is held there using the locking lugs 34. The B-flange 58 has openings 62 to suck in the air used for ventilation. The terminal lugs 56 are led to the outside along the outer circumference of the flange 58.

On the power supply side, the electric motor is closed by a circuit board 64. Hall sensors or other magnetic sensors 66 are mounted on the circuit board 64 to measure the rotational position of the motor. The Hall sensors 66 interact with a control magnet disk 68 that is mounted on a magnetic back yoke ring 69 and fixedly connected to the shaft 42 in order to generate the commutation signals necessary for the control of the electric motor. The control magnet disk 68 is disposed on the side of the ferromagnetic back yoke ring 69 facing the Hall sensors 66 so that the Hall sensors and the control magnet face each other.

The stator arrangement according to the invention creates an electric motor which is compact and which can be simply manufactured at low cost. In particular, the electric motor does not need a separate housing, and the insulating layer of the stator slots together with the housing sections can be manufactured in one production step. At the same time, the housing member is so designed that it allows for optimal external heat transfer in the stator. Moreover, the housing member is so expediently designed that the motor is easily assembled with connecting rings and end flanges.

The characteristics revealed in the above description, the claims and the figures can be important for the realization of the invention in its various embodiments both individually and in any combination whatsoever.

1. A stator arrangement for an electric machine comprising a stator body (10) having a number of stator teeth (14) between which stator slots (16) to receive stator windings are formed, and having an insulating layer (22) that is applied to the stator teeth (14) at least in the region of the stator slots (16) in which the stator windings are accommodated, the insulating layer (22) being integrally formed with a housing member (20) that is injection molded to the stator body (10), regions of the stator body (10) that do not receive any stator windings remaining at least partly uncovered.

2. A stator arrangement according to claim 1, wherein the stator body (10) is formed from a stack of laminations.

3. A stator arrangement according to claim 1, wherein the stator body (10) is injection molded essentially only in the region of the stator teeth (14).

4. A stator arrangement according to claim 1, wherein the stator body (10) is uncovered on its surface that faces away from the stator teeth (14).

5. A stator arrangement according to claim 1, wherein the housing member (20) has end housing sections (24, 26).

6. A stator arrangement according to claim 5, wherein the end housing sections (24, 26) have connecting elements (30; 34) to connect the housing to at least one flange (44; 58).

7. A stator arrangement according to claim 6, wherein the connecting elements comprise at least one of: locking elements (34), recesses, and holes (30).

8. A stator arrangement according to claim 1, wherein a flange is formed on one end face of the housing member (20).

9. A stator arrangement according to claim 1, wherein the stator body (10) has an inner rotor motor configuration having a back yoke ring (12) and stator teeth (14) projecting radially inwards from the back yoke ring (12), the insulating layer (22) and the housing member (20) being injection molded onto the stator body (10) such that the outside surface of the back yoke ring (12) remains uncovered.

10. An electric motor having a stator arrangement comprising a stator body (10) having a number of stator teeth (14) between which stator slots (16) to receive stator windings are formed, and having an insulating layer (22) that is applied to the stator teeth (14) at least in the region of the stator slots (16) in which the stator windings are accommodated, the insulating layer (22) being integrally formed with a housing member (20) that is injection molded to the stator body (10), regions of the stator body (10) that do not receive any stator windings remaining at least partly uncovered, wherein
the stator body (10) has an inner rotor motor configuration having a back yoke ring (12) and stator teeth (14) projecting radially inwards from the back yoke ring (12), the insulating layer (22) and the housing member (20) being injection molded onto the stator body (10) such that the outside surface of the back yoke ring (12) remains uncovered, and wherein
the housing member (20) has two housing sections (24, 26) on the opposing end faces of the stator body (10), the housing sections being substantially aligned with the back yoke ring (12).
